(19) United States
(12) Patent Application Publication
(10) Pub. No.: US 2005/0100702 A1
(43) Pub. Date: May 12, 2005

(54) Heat insulation flexible materials

(75) Inventor: Philippe Marchal, Vaucresson (FR)

Correspondence Address: PARKHURST & WENDEL, L.L.P., 1421 PRINCE STREET, SUITE 210, ALEXANDRIA, VA, 22314-2805, US

(73) Assignee: PCX, Louveciennes (FR)

(21) Appl. No.: 10/983,758

(22) Filed: Nov. 9, 2004

(30) Foreign Application Priority Data
Nov. 10, 2003 (FR) 03.13197

(51) Int. Cl. B32B 1/08

(52) U.S. Cl. 428/36.91; 428/126

(57) ABSTRACT

Heat insulating flexible material consisting of a stack of reflective elements, separated by an insert material, characterized in that it comprises a reflective foil on which is deposited an insert material in the form of a powder having a particle size distribution less than 1 μm, said reflective foil being coiled up or folded to delimit the reflective elements.

### BACKGROUND OF THE INVENTION

1. Field of Invention

The technical field of the present invention is that of high performance heat insulating materials.

2. Description of the Related Art

Insulators called super-insulators are known, that are made of reflective metallic or metal-sprayed sheets or foils, separated from one another by an insert generally made of a net or a felt. The principle of a super-insulator is to reduce heat exchanges through radiation without increasing exchanges by solid conduction, whilst avoiding gas conduction. This insulator is ideal for any insulating system in which pressure is in the range of 10⁻⁶ mbar, which corresponds to high vacuum.

A super-insulator presents a heat insulation coefficient of about 0.01 to 0.1 mW/(m.K) at a pressure of 10⁻⁶ mbar. The main drawback of super-insulators lies in the technical difficulties to obtain and maintain high vacuum.

Thus, an insulator made of aluminum-coated MYLAR® foils with polyester tulle as insert can be mentioned. Provided there is high vacuum (<10⁻⁶ bar), these insulating materials allow for conductivities in the range of 0.01 to 0.1 mW/(m.K). But in high temperatures applications, it has been suggested that MYLAR® foils be replaced with an aluminum foil and a paper or cotton foil, as insert. However, the increase in thickness due to these foils reduces considerably the insulator's efficiency by an estimated factor of 10. Furthermore, holding in compression is very bad because a load of 100 g/cm² brings the insulating foils closer together, increases surfaces of contact, thus solid conduction, and increases conductivity. Spacers are therefore necessary to maintain a minimum spacing between the sidewalls of the vacuum space. These spacers will increase local heat flows, which is detrimental to the global heat insulation of the system.

### SUMMARY OF THE INVENTION

The present invention suggests a innovative approach offering an insulator with excellent insulating property, combined with ease of implementation, which can be used at various pressures between 0.1 and 5.10⁶ Pa, and offering good compression holding. The aim of this invention is also to provide an excellent insulator for use at different pressures and in a wide range of temperature from cryogenic to high (>400° C.) temperatures.

The invention relates to a heat insulating flexible material, consisting of a stack of reflective elements, separated by an insert material, characterized in that it comprises a reflective foil on which is deposited an insert material in the form of a powder having a particle size distribution less than 1 μm, said reflective foil being coiled up or folded to delimit the reflective elements.

According to one characteristic of the invention, said insert material consists mainly of pyrogenic silica powder.

According to another characteristic of the invention, the powder has a basic particle size distribution of substantially 5 to 20 nm, and a density between 10 and 250 kg/m³ and an average pore size less than 1 μm.

According to another characteristic of the invention, the reflective foil is an aluminum foil between 5 and 100 microns thick.

According to another characteristic of the invention, the insert powder is placed in thickness between 10 and 300 microns.

According to another characteristic of the invention, the reflective foil is placed in successive layers inserted with powder.

According to another characteristic of the invention, the reflective foil is coiled up in spiral around a closed curved surface.

According to another characteristic of the invention, the reflective foil is zigzag-folded, with the powder placed between the various folds.

According to still another characteristic of the invention, reflective foils are placed side by side along a cover strip.

This invention also relates to the application of the material to insulation of a closed curved surface by spiral winding of the reflective foil.

An advantage of the material according to the invention is its high level of heat insulation at pressures ranging from 0.1 to 5.10⁶ Pa.

Another advantage of the material according to the invention, is to ensure a molecular-type gas flow between the reflective elements.

### BRIEF DESCRIPTION OF THE DRAWINGS

Other characteristics, details and advantages of the invention will be revealed from the detailed description given below as an indication in conjunction with the drawings in which:

FIG. 1 illustrates a first embodiment of the insulator according to the invention,

FIG. 2 illustrates a radial section for a second embodiment of the insulator according to the invention,

FIG. 3 illustrates another embodiment of the insulator according to the invention,

FIG. 4 illustrates a longitudinal section of an embodiment of the insulator according to the invention, as applied to a closed curve, and

FIG. 5 illustrates the embodiment of a large size-type insulator.

### DETAILED DESCRIPTION OF PREFERRED EMBODIMENTS

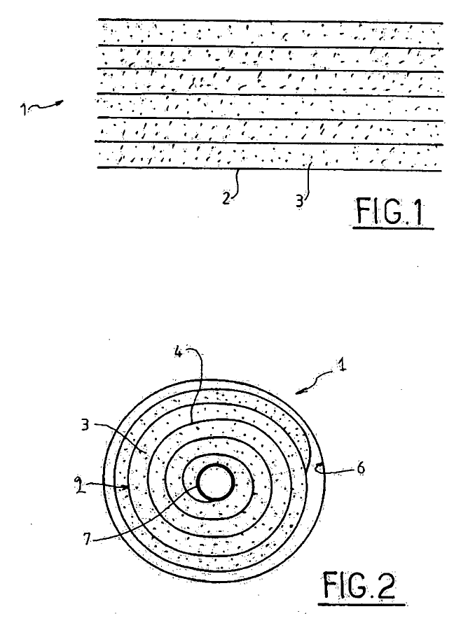

According to FIG. 1, a first example of insulator 1 design is given according to the invention, and obtained by stacking metallic foils 2 as the reflectors. These foils are separated by a thin layer of insert powder 3 making up the insert material. Each foil 2 is a reflective foil 4 of large size, previously covered with powder 3. Insert powder 3 can be placed on reflective foil 2 by putting it in a recipient containing said powder 3. The reflective foil 2 is advantageously a metallic foil, for example an aluminum foil.

An aluminum foil between 5 and 100 microns thick, commercially available in widths of about 1 m, is advantageously used. Powder 3 has the advantage of being of a particle size less than 1 μm and particularly between 5 to 20 nm and of a density between 10 and 250 kg/m³. This powder 3 is placed on each foil 2, with a thickness approximatively of 10 to 300 microns. It is clear that various thicknesses of the foil 2 may be used, or that the thickness may be varied in decreasing or increasing order. This is also valid for the layers of powder 3.

Insert material 3 can for instance be alumina, calcium silicate, and precipitated silica or titanium dioxide. The material used is advantageously presented in the form of a powdered pyrogenic silica. The pivotal quality of this powder 3 is that it presents a low solid conduction, and that its pore size is less than 1 micron. This allows to offer good insulating properties without limits in temperature of use (<1000° C.) and at various pressures of use.

For example, the following results are obtained at a temperature of 50° C.:

| Pressure (mbar) | Heat conductivity (mW/(m.K) |
|---|---|
| 0.05 | 1 |
| 100 | 14 |
| 1000 | 19 |

Thus, for temperatures less than 100° C. on the hot side and a pressure of around 0.05 mbar, a thermal conductivity of 0.5 to 1.5 mW/(m.K) is obtained.

It can be observed that the insulator according to the invention can accomplish performances well above those of a classic insulator of micro-porous type, and this at pressures similar to those obtained on an industrial scale, for example by on-site pumping. In addition, the insulating material according to the invention shows great flexibility, allowing coiling around tubes of any diameter, but especially small diameter in the order of 1 cm.

The insulating material can be used in a classical manner in any application requiring advanced insulation and upon which a force is applied. This is the case for instance of a tube, a container, etc. The material thus built shows great flexibility.

In FIG. 2, a section view of a specific application of insulator 1 is shown, used to protect a closed curved surface of cylindrical shape, such as a tube for instance. Insulator 1 is built by continuous spiral loops of a reflective foil 4 trapping insert powder 3 in successive layers. By operating radially outward from tube 7, it is possible to protect a succession of insulating elements. Reflective foil 4 prevents heat radiation in a known manner, and powder 3 prevents in an also known manner convection and conduction. Conduction is mainly avoided by preventing any contact between the various loops of reflective foil 4. This function is ensured by insert powder 3, which serves as a spacer between the successive loops of foil 4. The last loop of insulator 1 is protected by a suitable device 6, a rim or a thin metal foil.

The insulator is coiled around tube 7 as follows. Tube 7 is for instance rotated upon its axis using a device not shown, so that reflective foil 4 and powder 3 can be coiled around it. Reflective foil 4 then takes up the shape of a spiral between which loops an approximately constant thickness of powder 5 is trapped. Powder 3 is placed on the foil as previously indicated. It is clear that this setup can be applied to any closed curved surface.

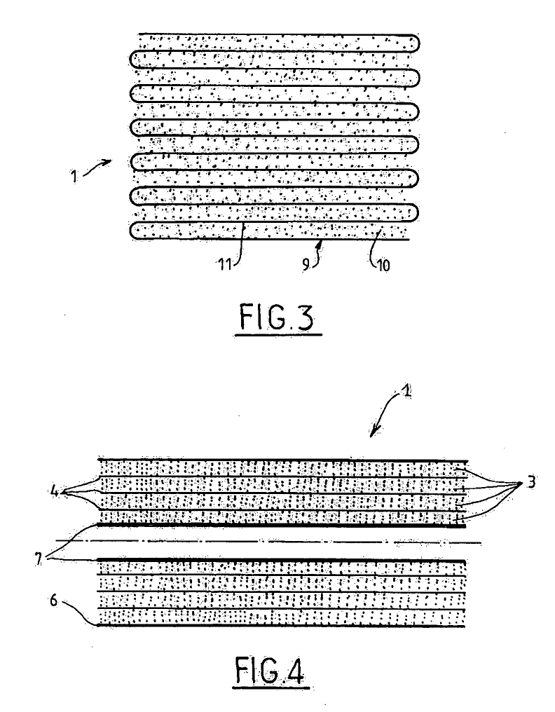

In FIG. 3, another embodiment of the insulator 2 is shown, using a unique foil 9 folded in zigzag, with each fold 11 separated by a coat of powder 10. Foil 9 and powder 10 are of the same material as foil 4 and powder 3. It is obvious that insulating material obtained this way may be used in pipes, containers or any other application.

The paragraphs above describe an insert material of powder type.

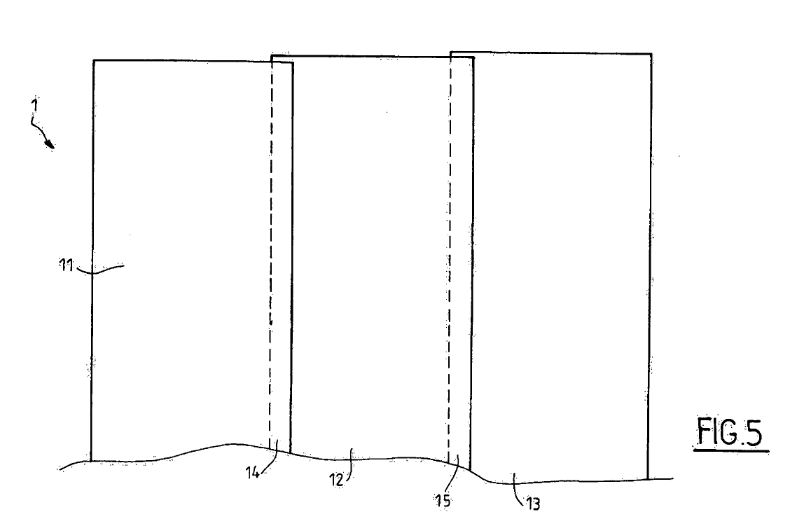

FIG. 4 shows a longitudinal view of tube 7 protected by the insulator according to FIG. 2. After coiling foil 4, coated with powder 3 around tube 7. It is advantageous to band the coiled insulator made up of reflective foil 4 by using a cylindrical splint rim 6, which can be easily manufactured by those skilled in the art.

The splint rim 6 ensures better cohesion of the insulating assembly around tube 7 and limits any possible shift of powder 3 on curved surfaces.

Such an embodiment only makes use of silica and alumina for the insulating parts. This allows the whole unit to increase in temperature. The fact that the tube can be coiled and that only materials withstanding high temperature are used, makes the baking of such a tube practically possible.

In the previous figures, the various sectional views show clearly the position of the various loops or folds delimited by foil 4, separated by powder film 3 or 10. It stands to reason that the spacing between loops or folds is enlarged for the sake of the drawing. It is also obvious that foil and powder are in intimate contact, as previously explained.

FIG. 5 illustrates an embodiment of the insulator 1, of sizable width to protect a very long tube. Foils 11, 12 and 13, commercially easily available are used in this aim and placed side by side according to the desired width, the desired length of each foil being by definition adjustable according to the user's requirements. In order to ensure reflection continuity of the reflective foils, each foil is placed with a partial overlap strip. Shown in the figure are overlap strip 14 between foils 11 and 12 and overlap strip 15 between foils 12 and 13. This method makes it possible to fabricate an insulator of a large size by using spiral coiling around a tube or enclosure, or by using zigzag folding as shown in FIG. 3.

1. Heat insulating flexible material consisting of a stack of reflective elements, separated by an insert material, characterized in that said material comprises a reflective foil on which is deposited an insert material in the form of a powder having a particle size distribution less than 1 μm, said reflective foil being coiled up or folded to delimit said reflective elements.

2. Heat insulating flexible material according to claim 1, characterized in that said insert material consists of pyrogenic silica powder.

3. Heat insulating flexible material according to claim 2, characterized in that said insert material presents a particle size distribution of substantially 5 to 20 nm, and a density of between 10 and 250 kg/m³ and an average pore size less than 1 μm.

4. Heat insulating material (1) according to claim 1, characterized in that said reflective foil is an aluminum foil between approximately 5 and 100 microns thick.

5. Heat insulating material (1) according to claim 1, characterized in that said insert material is placed with a thickness of between 10 and 300 microns.

6. Heat insulating flexible material according to claim 1, characterized in that said reflective foil is placed in successive layers between which said insert material is placed.

7. Heat insulating flexible material according to claim 1, characterized in that said reflective foil is coiled up in spiral around a closed curved surface.

8. Heat insulating flexible material according to claim 1, characterized in that said reflective foil is zigzag-folded, said insert material being placed between the various folds.
